(19) United States
(12) Patent Application Publication
(10) Pub. No.: US 2018/0063588 A1
(43) Pub. Date: Mar. 1, 2018

(54) RETRIEVING CONTENT RATINGS THROUGH RETURN PATH AND CONSOLIDATING RATINGS ONTO VIDEO STREAMS

(71) Applicant: ARRIS Enterprises LLC, Suwanee, GA (US)

(72) Inventors: Rene Martinez Esquivel, San Nicolas de los Garza (MX); Osvaldo Mendoza Narro, Escobedo (MX); Jose Alberto Gastelum Moreno, Apodaca (MX)

(21) Appl. No.: 15/254,963

(22) Filed: Sep. 1, 2016

(51) Int. Cl. H04N 21/475; H04N 21/442; H04N 21/435; H04N 21/482; H04N 21/235

(52) U.S. Cl. CPC H04N 21/4758; H04N 21/44222; H04N 21/235; H04N 21/4821; H04N 21/435

(57) ABSTRACT

Methods, systems, and computer readable media can be operable to facilitate a generation of a content rating based upon user input and an insertion of the content rating into a video stream. A user interface may be utilized at a multimedia device to gather user input including a rating assigned to a piece of content by the user. The user input including the content rating may be output from the multimedia device to an upstream system over a return path. The upstream system may consolidate the received content rating with other ratings associated with the piece of content and may generate an aggregate rating for the piece of content. The aggregate rating may be inserted, as metadata, into a transport stream carrying the piece of content, and the piece of content, along with the metadata representing the aggregate rating, may be output to one or more multimedia devices.

### TECHNICAL FIELD

This disclosure relates to the retrieval of content ratings over a return path and the consolidation of the content ratings onto a video stream.

### BACKGROUND

Television viewers are exposed to a large variety of video content that is available for viewing, making difficult the viewers' decision on what to watch. Available program information such as electronic program guides (EPG) and other program scheduling information does not provide information over broadcast networks such as satellite and cable networks that informs a viewer as to the feedback or opinions of other viewers for a piece of content. Therefore, it is desirable to improve upon methods and systems for creating and delivering viewer content ratings within an associated video stream.

### BRIEF DESCRIPTION OF THE DRAWINGS

FIG. 1 is a block diagram illustrating an example network environment operable to facilitate a generation of a content rating based upon user input and an insertion of the content rating into a video stream.

FIG. 2 is a block diagram illustrating an example system operable to facilitate a generation of a content rating based upon user input and an insertion of the content rating into a video stream.

FIG. 3 is a flowchart illustrating an example process operable to facilitate a generation of a content rating based upon user input and an insertion of the content rating into a video stream.

FIG. 4 is a block diagram of a hardware configuration operable to facilitate a generation of a content rating based upon user input and an insertion of the content rating into a video stream.

Like reference numbers and designations in the various drawings indicate like elements.

### DETAILED DESCRIPTION

It is desirable to improve upon methods and systems for creating and delivering viewer content ratings within an associated video stream. Methods, systems, and computer readable media can be operable to facilitate a generation of a content rating based upon user input and an insertion of the content rating into a video stream. A user interface may be utilized at a multimedia device to gather user input including a rating assigned to a piece of content by the user. The user input including the content rating may be output from the multimedia device to an upstream system over a return path. The upstream system may consolidate the received content rating with other ratings associated with the piece of content and may generate an aggregate rating for the piece of content. The aggregate rating may be inserted, as metadata, into a transport stream carrying the piece of content, and the piece of content, along with the metadata representing the aggregate rating, may be output to one or more multimedia devices.

An embodiment of the invention described herein may include a method comprising: (a) receiving a rating for a piece of content, wherein the rating is input by a user at a multimedia device, and wherein the rating is received from the multimedia device over a return path, the return path providing a communication link between the multimedia device and a headend system located upstream from the multimedia device; (b) generating an aggregate rating associated with the piece of content, wherein the aggregate rating comprises a summary metric that accounts for the received rating and at least one other rating associated with the piece of content; (c) inserting the aggregate rating into a transport stream carrying the piece of content; and (d) outputting the transport stream from the headend system.

According to an embodiment of the invention, the aggregate rating is inserted into the transport stream as metadata.

According to an embodiment of the invention, the aggregate rating is inserted into a program and system information protocol extended-text-table of the transport stream.

According to an embodiment of the invention, the rating is received by a return path demodulator of the headend system.

According to an embodiment of the invention, the transport stream output from the headend system is received by another multimedia device, and the other multimedia device decodes and presents the aggregate rating within a display.

According to an embodiment of the invention, the summary metric comprises an average of the received rating and at least one other rating associated with the piece of content.

According to an embodiment of the invention, the rating is received from the multimedia device and the transport stream is output from the headend system over a community access television network.

An embodiment of the invention described herein may include a headend system comprising: (a) an input interface configured to be used to receive a rating for a piece of content, wherein the rating is input by a user at a multimedia device, and wherein the rating is received from the multimedia device over a return path, the return path providing a communication link between the multimedia device and the headend system; (b) a rating consolidation module configured to generate an aggregate rating associated with the piece of content, wherein the aggregate rating comprises a summary metric that accounts for the received rating and at least one other rating associated with the piece of content; (c) a metadata insertion module configured to insert the aggregate rating into a transport stream carrying the piece of content; and (d) an output interface configured to be used to output the transport stream.

An embodiment of the invention described herein may include one or more non-transitory computer readable media having instructions operable to cause one or more processors to perform the operations comprising: (a) receiving a rating for a piece of content, wherein the rating is input by a user at a multimedia device, and wherein the rating is received from the multimedia device over a return path, the return path providing a communication link between the multimedia device and a headend system located upstream from the multimedia device; (b) generating an aggregate rating associated with the piece of content, wherein the aggregate rating comprises a summary metric that accounts for the received rating and at least one other rating associated with the piece of content; (c) inserting the aggregate rating into a transport stream carrying the piece of content; and (d) outputting the transport stream from the headend system.

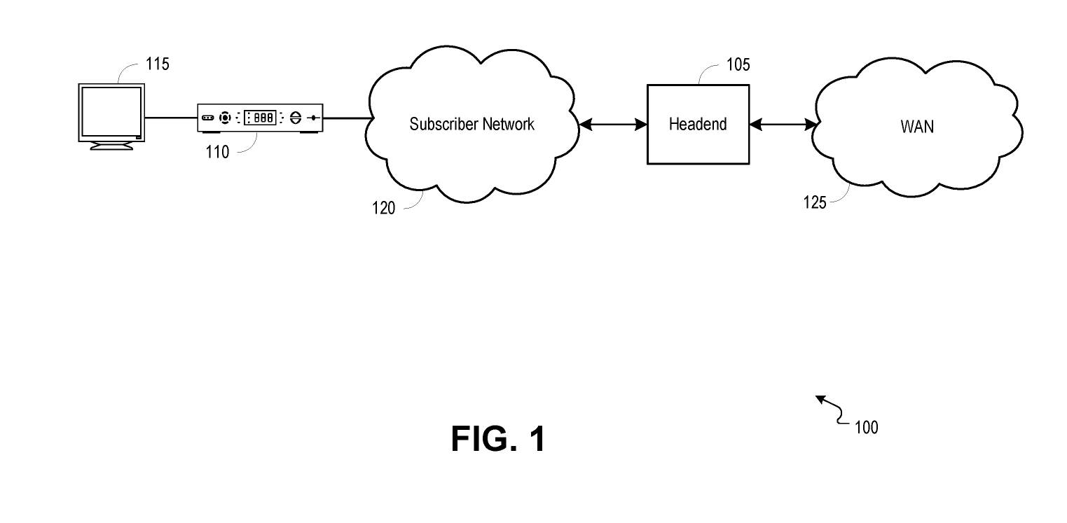

FIG. 1 is a block diagram illustrating an example network environment 100 operable to facilitate a generation of a content rating based upon user input and an insertion of the content rating into a video stream. In embodiments, a headend 105 may provide video, data and/or voice service(s) to one or more customer premise equipment (CPE) devices. For example, the headend 105 may provide video and/or data services to a multimedia device 110 (e.g., a set-top box (STB), multimedia gateway, etc.), and content received at the multimedia device 110 may be output to a display device 115 (e.g., television, computer, tablet, mobile device, etc.). The various data, multimedia, and/or voice services provided from the headend 105 to the multimedia device 110 may include, but is not limited to, live or broadcast television, video-on-demand (VoD) content, pay-per view content, recorded content (e.g., DVR content), audio-only content, streaming content, and others.

The multimedia device 110 may communicate with the headend 105 via a subscriber network 120. The subscriber network 120 may be a hybrid fiber-coax (HFC) network, fiber network, mobile network, or other network capable of delivering one or more services to a subscriber premise. The headend 105 may include one or more devices or modules such as a cable modem termination system (CMTS), an edge quadrature amplitude modulation (EQAM) device, a combined or converged device including multiple edge and/or video or data processing functionalities, and/or various other devices. Such devices may operate to facilitate the delivery of communications between a WAN 125 and the multimedia device 110. In embodiments, the WAN 125 may include one or more networks internal to the headend 105 and/or one or more networks external to the headend 105 (e.g., one or more extranets, the Internet, etc.).

In embodiments, multimedia content may be received at a multimedia device 110 as a content stream. The content may be delivered to the multimedia device 110 as a stream of packets or frames (e.g., IP (Internet protocol) stream, MPEG (moving picture experts group) stream, etc.), and the packets or frames may be decoded and processed for presentation to a user through a connected display device 115. Content may be delivered to a multimedia device 110 by a community access television (CATV) system or network.

In embodiments, a user interface may be displayed at a display device 115 by a multimedia device 110. The user interface may prompt a user for the input of feedback regarding a particular piece of content (e.g., a piece of content currently being viewed by the user, a piece of content stored at the multimedia device 110, a piece of content previously viewed by the user, etc.). For example, the user interface may request user input of a score or rating (e.g., numeric or alphanumeric score, scaled rating, etc.) for a selected piece of content. The user may interact with the user interface and may input a score or rating using a control interface associated with the multimedia device 110 (e.g., remote control unit (RCU)).

In embodiments, the communication link between the headend 105 and the multimedia device 110 may include a return path facilitating the transmission of communications from the multimedia device 110 to the headend 105. For example, the return path may support the delivery of communications from a multimedia device 110 to the headend 105 that are associated with interactive applications (e.g., purchasing pay-per-view content). A content rating input at a multimedia device 110 by a user may be output from the multimedia device 110 to the headend 105 as a communication along the return path.

In embodiments, the headend 105 may process a content rating that is received from a multimedia device 110 along the return path and may add the content rating to a database at which one or more ratings for one or more pieces of content are stored. For example, the headend 105 may maintain a database that includes one or more ratings that are received from one or more subscribers and are associated with one or more pieces of content. The headend 105 may update the database with each content rating received from a multimedia device 110. Using the information stored within the database, the headend 105 may generate an aggregate rating summary or metric (e.g., a summary metric such as an average, mean, median, etc.) that takes into consideration each of one or more ratings that are received for each of one or more pieces of content. For example, the headend 105 may generate an aggregate rating for a piece of content by taking the average of a plurality of ratings stored within the database for the piece of content.

In embodiments, the headend 105 may store a received content rating within a database associated with the subscriber from which the rating was received. The headend 105 may generate a subscriber profile using the one or more content ratings stored at the database, wherein the subscriber profile identifies the programs that the subscriber likes and/or dislikes. The subscriber profile may be further used by the headend 105 to provide recommendations to the subscriber of other programs that the user might enjoy, wherein the recommendation is based on similarities between the other programs and the programs which the subscriber has given a high score or rating. The recommendation may be based upon identified correlations between the pieces of content favored by other subscriber profiles.

In embodiments, the headend 105 may insert an aggregate rating into a program transport stream or video stream carrying the piece of content with which the aggregate rating is associated. The aggregate rating for a piece of content may be inserted into metadata of a broadcast, multicast, or unicast stream that is carrying the piece of content and is output from the headend 105 to one or more multimedia devices 110. For example, the aggregate rating may be inserted as metadata along with a program title, description, and/or other information associated with the piece of content.

In embodiments, a multimedia device 110 may decode the metadata carried by a received program transport or video stream, recognize an aggregate rating from the metadata, and display the aggregate rating at a display device 115. For example, the aggregate rating may be displayed within a channel guide (e.g., as electronic program guide (EPG) data), within a program information window displayed when the piece of content is output to a display device 115, or overlaying the display of the piece of content at a display device 115.

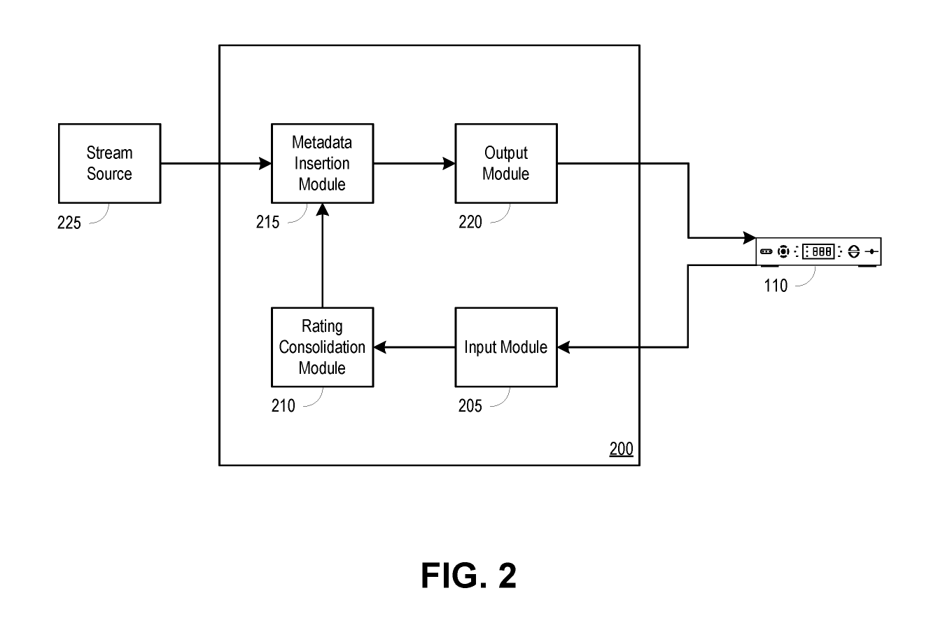

FIG. 2 is a block diagram illustrating an example system 200 operable to facilitate a generation of a content rating based upon user input and an insertion of the content rating into a video stream. The system 200 may include an input module 205, a rating consolidation module 210, a metadata insertion module 215, and an output module 220. In embodiments, one or more components of the system 200 may reside at a headend 105 of FIG. 1.

In embodiments, multimedia content may be received at the system 200 from a stream source 225. For example, multimedia content may be received from a stream source 225 that is located external to the system 200 within an upstream network (e.g., WAN 125 of FIG. 1) as a content stream (e.g., Internet protocol (IP) stream, MPEG stream, etc.), or the content may be received from a stream source 225 that is located within the system 200 (e.g., within a headend 105 of FIG. 1).

In embodiments, a user input of a content score or rating may be received at the input module 205 from a multimedia device 110. The user input may include a rating assigned to a piece of content by a user. The user input may be output from the multimedia device 110 to the input module 205 as a communication delivered over a return path, the return path providing an upstream link between the multimedia device 110 and the input module 205. For example, the input module 205 may include one or more return path demodulators. The content score or rating provided by a user may be processed and structured by the multimedia device 110 such that the information may be delivered to the system 200 via the return path. The return path may include out-of-band reverse data channels (OBB RDC), or other similarly defined channel group. For example, the information associated with the content score or rating may be transmitted as the payload of an upstream packet. The upstream packet carrying the content score or rating information may include an upstream MAC (media access control) address that identifies a return multimedia device (e.g., the multimedia device 110).

At the physical layer level, the content score or rating information may be modulated by the return multimedia device 110 (e.g., QPSK (quadrature phase shift keying) modulation) to meet transmission requirements for the upstream channel. The return multimedia device 110 may transmit the content score or rating information to the system 200 via an upstream carrier. The carrier signal may then be demodulated by the input module 205, and the information carried by the carrier signal may be converted to Ethernet TCP (transmission control protocol)/IP (Internet protocol) data packets by a return path demodulator (RPD) of the input module 205. The data packets may then be output to a module wherein the content score or rating information may be extracted from the data packets.

In embodiments, the input module 205 may process a content rating that is received from a multimedia device 110 along the return path and may add the content rating to a database at which one or more ratings for one or more pieces of content are stored. For example, the rating consolidation module 210 may maintain a database (e.g., at a server within or external to the system 200) that includes one or more ratings that are received from one or more subscribers and are associated with one or more pieces of content. The rating consolidation module 210 may update the database with each content rating received from a multimedia device 110. Using the information stored within the database, the rating consolidation module 210 may generate an aggregate rating summary or metric that takes into consideration each of one or more ratings that are received for each of one or more pieces of content. For example, the rating consolidation module 210 may generate an aggregate rating for a piece of content by taking the average of a plurality of ratings stored within the database for the piece of content.

In embodiments, the metadata insertion module 215 may insert an aggregate rating into a program transport stream or video stream carrying the piece of content with which the aggregate rating is associated. The aggregate rating for a piece of content may be inserted into metadata of a broadcast, multicast, or unicast stream that is carrying the piece of content. For example, the metadata insertion module 215 may receive a video stream from a stream source 225, identify an aggregate rating associated with the content carried by the video stream from the rating consolidation module 210, and insert the identified aggregate rating into the video stream as metadata.

In embodiments, the video stream carrying the aggregate rating as metadata may be output from the output module 220 to one or more multimedia devices 110. For example, the output module 220 may include an edge QAM (quadrature amplitude modulation) module. A multimedia device 110 receiving the video stream output from the output module 220 may decode the metadata carried by a received program transport or video stream, recognize an aggregate rating from the metadata, and display the aggregate rating at a display (e.g., display device 115 of FIG. 1). For example, the aggregate rating may be displayed within a channel guide (e.g., as electronic program guide (EPG) data), within a program information window displayed when the piece of content is output to a display device 115, or overlaying the display of the piece of content at a display device 115.

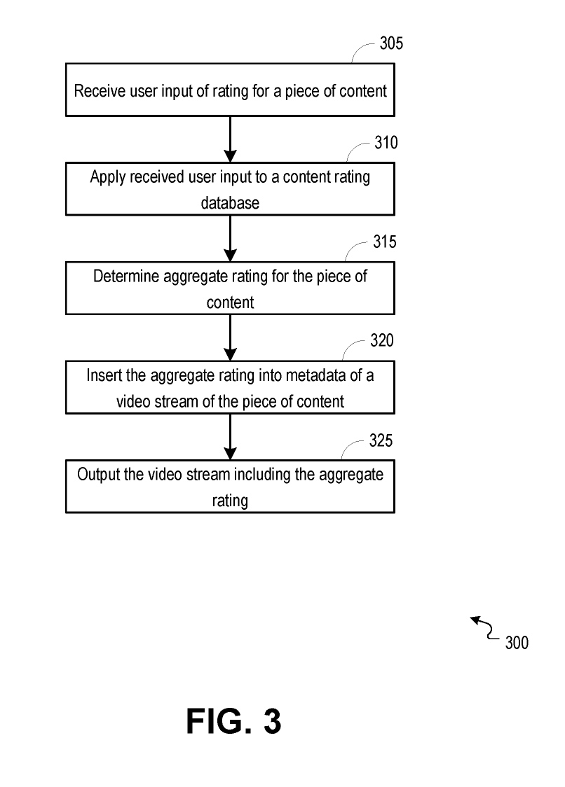

FIG. 3 is a flowchart illustrating an example process 300 operable to facilitate a generation of a content rating based upon user input and an insertion of the content rating into a video stream. The process 300 may begin at 305 when a user input of a rating for a piece of content is received. The user input may be received, for example, by an upstream system (e.g., input module 205 of FIG. 2). The content rating may be input by a user at a CPE device (e.g., multimedia device 110 of FIG. 1), and the content rating may be delivered form the CPE device to the upstream system via a return path. In embodiments, the user input may include information identifying a user/subscriber from which the input was received, an identification of the piece of content with which the rating is associated, a numeric/alphanumeric rating of the associated content, and any other information that may provide a summary of the user's opinion of the associated content.

At 310, the received user input may be applied to a content rating database. For example, the user input may be applied to a database stored at a headend (e.g., at a rating consolidation module 210 of FIG. 2). In embodiments, the database may store one or more ratings associated with one or more pieces of content. The rating consolidation module 210 may receive the user input, identify the piece of content within the database or add the piece of content to the database, and add the rating identified from the user input to the database.

At 315, an aggregate rating for the piece of content may be determined. The aggregate rating for the piece of content may be determined, for example, by the rating consolidation module 210. In embodiments, the rating consolidation module 210 may generate a metric that accounts for one or more ratings that have been received as a user input and that are associated with the piece of content. For example, the rating consolidation module 210 may determine an average of the one or more ratings associated with the piece of content.

At 320, the aggregate rating may be inserted into metadata of a video stream of the piece of content. The aggregate rating may be inserted into metadata of the video stream (or program transport stream), for example, by a metadata insertion module 215 of FIG. 2. In embodiments, the aggregate rating may be inserted into the video stream's PSIP (program and system information protocol) extended-text-table (ETT).

At 325, the video stream including the aggregate rating may be output. For example, the video stream may be broadcast, multicast, or unicast to one or more subscribers or subscriber devices (e.g., multimedia device 110 of FIG. 1). The output video stream may include metadata carrying information associated with an individual ranking or an aggregate ranking associated with the piece of content carried by the video stream. In embodiments, a multimedia device 110 receiving the video stream may decode the metadata and may present the content rating information to a viewer. For example, the multimedia device 110 may cause the content rating information to be displayed within EPG (electronic program guide) information or along with other identifying information associated with the piece of content (e.g., title, description, etc.).

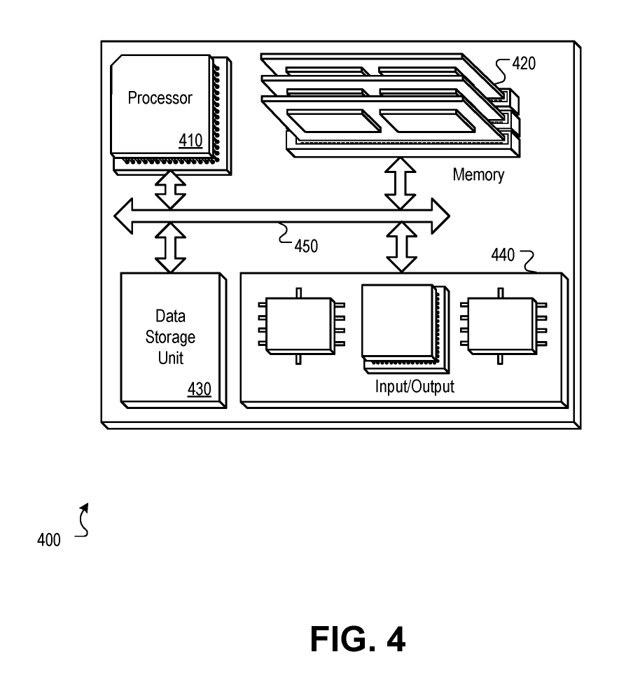

FIG. 4 is a block diagram of a hardware configuration 400 operable to facilitate a generation of a content rating based upon user input and an insertion of the content rating into a video stream. The hardware configuration 400 can include a processor 410, a memory 420, a storage device 430, and an input/output device 440. Each of the components 410, 420, 430, and 440 can, for example, be interconnected using a system bus 450. The processor 410 can be capable of processing instructions for execution within the hardware configuration 400. In one implementation, the processor 410 can be a single-threaded processor. In another implementation, the processor 410 can be a multi-threaded processor. The processor 410 can be capable of processing instructions stored in the memory 420 or on the storage device 430.

The memory 420 can store information within the hardware configuration 400. In one implementation, the memory 420 can be a computer-readable medium. In one implementation, the memory 420 can be a volatile memory unit. In another implementation, the memory 420 can be a non-volatile memory unit.

In some implementations, the storage device 430 can be capable of providing mass storage for the hardware configuration 400. In one implementation, the storage device 430 can be a computer-readable medium. In various different implementations, the storage device 430 can, for example, include a hard disk device, an optical disk device, flash memory or some other large capacity storage device. In other implementations, the storage device 430 can be a device external to the hardware configuration 400.

The input/output device 440 provides input/output operations for the hardware configuration 400. In one implementation, the input/output device 440 can include one or more of a network interface device (e.g., an Ethernet card), a serial communication device (e.g., an RS-232 port), one or more universal serial bus (USB) interfaces (e.g., a USB 2.0 port), one or more wireless interface devices (e.g., an 802.11 card), and/or one or more interfaces for outputting video, voice, and/or data services to a display device (e.g., display device 115 of FIG. 1). In embodiments, the input/output device can include driver devices configured to send communications to, and receive communications from one or more networks (e.g., local network, subscriber network 120 of FIG. 1, WAN 125 of FIG. 1, etc.).

Those skilled in the art will appreciate that the invention improves upon methods and systems for creating and delivering viewer content ratings within an associated video stream. Methods, systems, and computer readable media can be operable to facilitate a generation of a content rating based upon user input and an insertion of the content rating into a video stream. A user interface may be utilized at a multimedia device to gather user input including a rating assigned to a piece of content by the user. The user input including the content rating may be output from the multimedia device to an upstream system over a return path. The upstream system may consolidate the received content rating with other ratings associated with the piece of content and may generate an aggregate rating for the piece of content. The aggregate rating may be inserted, as metadata, into a transport stream carrying the piece of content, and the piece of content, along with the metadata representing the aggregate rating, may be output to one or more multimedia devices.

The subject matter of this disclosure, and components thereof, can be realized by instructions that upon execution cause one or more processing devices to carry out the processes and functions described above. Such instructions can, for example, comprise interpreted instructions, such as script instructions, e.g., JavaScript or ECMAScript instructions, or executable code, or other instructions stored in a computer readable medium.

Implementations of the subject matter and the functional operations described in this specification can be provided in digital electronic circuitry, or in computer software, firmware, or hardware, including the structures disclosed in this specification and their structural equivalents, or in combinations of one or more of them. Embodiments of the subject matter described in this specification can be implemented as one or more computer program products, i.e., one or more modules of computer program instructions encoded on a tangible program carrier for execution by, or to control the operation of, data processing apparatus.

A computer program (also known as a program, software, software application, script, or code) can be written in any form of programming language, including compiled or interpreted languages, or declarative or procedural languages, and it can be deployed in any form, including as a stand-alone program or as a module, component, subroutine, or other unit suitable for use in a computing environment. A computer program does not necessarily correspond to a file in a file system. A program can be stored in a portion of a file that holds other programs or data (e.g., one or more scripts stored in a markup language document), in a single file dedicated to the program in question, or in multiple coordinated files (e.g., files that store one or more modules, sub programs, or portions of code). A computer program can be deployed to be executed on one computer or on multiple computers that are located at one site or distributed across multiple sites and interconnected by a communication network.

The processes and logic flows described in this specification are performed by one or more programmable processors executing one or more computer programs to perform functions by operating on input data and generating output thereby tying the process to a particular machine (e.g., a machine programmed to perform the processes described herein). The processes and logic flows can also be performed by, and apparatus can also be implemented as, special purpose logic circuitry, e.g., an FPGA (field programmable gate array) or an ASIC (application specific integrated circuit).

Computer readable media suitable for storing computer program instructions and data include all forms of non-volatile memory, media and memory devices, including by way of example semiconductor memory devices (e.g., EPROM, EEPROM, and flash memory devices); magnetic disks (e.g., internal hard disks or removable disks); magneto optical disks; and CD ROM and DVD ROM disks. The processor and the memory can be supplemented by, or incorporated in, special purpose logic circuitry.

While this specification contains many specific implementation details, these should not be construed as limitations on the scope of any invention or of what may be claimed, but rather as descriptions of features that may be specific to particular embodiments of particular inventions. Certain features that are described in this specification in the context of separate embodiments can also be implemented in combination in a single embodiment. Conversely, various features that are described in the context of a single embodiment can also be implemented in multiple embodiments separately or in any suitable subcombination. Moreover, although features may be described above as acting in certain combinations and even initially claimed as such, one or more features from a claimed combination can in some cases be excised from the combination, and the claimed combination may be directed to a subcombination or variation of a sub combination.

Similarly, while operations are depicted in the drawings in a particular order, this should not be understood as requiring that such operations be performed in the particular order shown or in sequential order, or that all illustrated operations be performed, to achieve desirable results. In certain circumstances, multitasking and parallel processing may be advantageous. Moreover, the separation of various system components in the embodiments described above should not be understood as requiring such separation in all embodiments, and it should be understood that the described program components and systems can generally be integrated together in a single software product or packaged into multiple software products.

Particular embodiments of the subject matter described in this specification have been described. Other embodiments are within the scope of the following claims. For example, the actions recited in the claims can be performed in a different order and still achieve desirable results, unless expressly noted otherwise. As one example, the processes depicted in the accompanying figures do not necessarily require the particular order shown, or sequential order, to achieve desirable results. In some implementations, multitasking and parallel processing may be advantageous.

1. A method comprising:
outputting a piece of content to a multimedia device, wherein the piece of content is output from a headend system to the multimedia device over a downstream communication link of a community access television network;
receiving a rating for a piece of content, wherein the rating is input by a user at the multimedia device, wherein the rating for the piece of content is received at the headend system located upstream from the multimedia device, and wherein the rating is received from the multimedia device over a return path within the community access television network, the return path providing an upstream communication link from the multimedia device to the headend system, and wherein the rating is modulated through quadrature phase shift keying modulation and transmitted from the multimedia device along an upstream carrier signal, wherein the upstream carrier signal is received and demodulated by a return path demodulator, wherein the upstream carrier signal is converted to Internet protocol data packets, and wherein the rating is extracted from the Internet protocol data packets;
generating an aggregate rating associated with the piece of content, wherein the aggregate rating comprises a summary metric that accounts for the received rating and at least one other rating associated with the piece of content;
identifying a transport stream carrying a video stream associated with the piece of content;
inserting the aggregate rating associated with the piece of content into the transport stream; and
outputting the transport stream from the headend system.

2. The method of claim 1, wherein the aggregate rating is inserted into the transport stream as metadata.

3. The method of claim 1, wherein the aggregate rating is inserted into a program and system information protocol extended-text-table of the transport stream.

4. The method of claim 1, wherein the rating is received by a return path demodulator of the headend system.

5. The method of claim 1, wherein the transport stream output from the headend system is received by another multimedia device, and wherein the other multimedia device decodes and presents the aggregate rating within a display.

6. The method of claim 1, wherein the summary metric comprises an average of the received rating and at least one other rating associated with the piece of content.

7. (canceled)

8. A headend system comprising:
an output interface that outputs a piece of content to a multimedia device, wherein the piece of content is output to the multimedia device over a downstream communication link of a community access television network;
an input interface that receives a rating for the piece of content, wherein the rating is input by a user at the multimedia device, and wherein the rating is received from the multimedia device over a return path within the community access television network, the return path providing an upstream communication link from the multimedia device to the headend system, and wherein the rating is modulated through quadrature phase shift keying modulation and transmitted from the multimedia device along an upstream carrier signal, wherein the upstream carrier signal is received and demodulated by a return path demodulator, wherein the upstream carrier signal is converted to Internet protocol data packets, and wherein the rating is extracted from the Internet protocol data packets;
a rating consolidation module that generates an aggregate rating associated with the piece of content, wherein the aggregate rating comprises a summary metric that accounts for the received rating and at least one other rating associated with the piece of content;
a metadata insertion module that identifies a transport stream carrying a video stream associated with the piece of content and inserts the aggregate rating into the transport stream carrying the piece of content; and
wherein the output interface outputs the transport stream.

9. The headend system of claim 8, wherein the aggregate rating is inserted into the transport stream as metadata.

10. The headend system of claim 8, wherein the aggregate rating is inserted into a program and system information protocol extended-text-table of the transport stream.

11. The headend system of claim 8, wherein the input interface comprises a return path demodulator.

12. The headend system of claim 8, wherein the output transport stream is received by another multimedia device, and wherein the other multimedia device decodes and presents the aggregate rating within a display.

13. (canceled)

14. One or more non-transitory computer readable media having instructions operable to cause one or more processors to perform the operations comprising:
outputting a piece of content to a multimedia device, wherein the piece of content is output from a headend system to the multimedia device over a downstream communication link of a community access television network;
receiving a rating for a piece of content, wherein the rating is input by a user at the multimedia device, wherein the rating for the piece of content is received at the headend system located upstream from the multimedia device, and wherein the rating is received from the multimedia device over a return path within the community access television network, the return path providing an upstream communication link from the multimedia device to the headend system, and wherein the rating is modulated through quadrature phase shift keying modulation and transmitted from the multimedia device along an upstream carrier signal, wherein the upstream carrier signal is received and demodulated by a return path demodulator, wherein the upstream carrier signal is converted to Internet protocol data packets, and wherein the rating is extracted from the Internet protocol data packets;
generating an aggregate rating associated with the piece of content, wherein the aggregate rating comprises a summary metric that accounts for the received rating and at least one other rating associated with the piece of content;
identifying a transport stream carrying a video stream associated with the piece of content;
inserting the aggregate rating associated with the piece of content into the transport stream; and
outputting the transport stream from the headend system.

15. The one or more non-transitory computer-readable media of claim 14, wherein the aggregate rating is inserted into the transport stream as metadata.

16. The one or more non-transitory computer-readable media of claim 14, wherein the aggregate rating is inserted into a program and system information protocol extended-text-table of the transport stream.

17. The one or more non-transitory computer-readable media of claim 14, wherein the rating is received by a return path demodulator of the headend system.

18. The one or more non-transitory computer-readable media of claim 14, wherein the transport stream output from the headend system is received by another multimedia device, and wherein the other multimedia device decodes and presents the aggregate rating within a display.

19. The one or more non-transitory computer-readable media of claim 14, wherein the summary metric comprises an average of the received rating and at least one other rating associated with the piece of content.

20. (canceled)
